(19) United States
(12) Patent Application Publication
(10) Pub. No.: US 2022/0014355 A1
(43) Pub. Date: Jan. 13, 2022

(54) Oblivious Comparisons and Quicksort of Secret Shared Arithmetic Values in a Multi-Party Computing Setting

(71) Applicant: Inpher, Inc., New York, NY (US)

(72) Inventors: Nicolas Gama, Lausanne (CH); Mariya Georgieva, Nanterre (FR); Kevin Deforth, Lausanne (CH); Dimitar Jetchev, St-Saphorin-Lavaux (CH)

(21) Appl. No.: 17/464,600

(22) Filed: Sep. 1, 2021

Related U.S. Application Data
(63) Continuation-in-part of application No. 17/374,956, filed on Jul. 13, 2021.
(60) Provisional application No. 63/051,317, filed on Jul. 13, 2020.
(60) Provisional application No. 63/073,419, filed on Sep. 1, 2020.

(51) Int. Cl. H04L 9/08; H04L 29/06

(52) U.S. Cl. CPC H04L 9/085; H04L 2209/46; H04L 63/04; H04L 9/0894

(57) ABSTRACT

An oblivious comparison method takes as input two secret shared numerical values x and y and outputs a secret shared bit that is the result of the comparison of x and y (e.g. 1 if x<y and 0 otherwise). The method uses secure multi-party computation, allowing multiple parties to collaboratively perform the comparison while keeping the inputs private and revealing only the result. The two secret shared values are subtracted to compute a secret shared result, the sign of which indicates the result of the comparison. The method decomposes the secret shared result into a masked Boolean representation and then performs a bit-wise addition of the mask and the masked result. Through the bit-wise addition the method can extract a secret shared representation of the most significant bit, which indicates the sign of the result, without revealing the result itself.

### RELATED APPLICATIONS

The subject matter of this application is related to U.S. patent application Ser. No. 17/374,956, filed on 2021 Jul. 13, U.S. patent application Ser. No. 17/093,008, filed on 2020 Nov. 9, now U.S. Pat. No. 11,050,558, U.S. Provisional Application No. 63/073,419, filed on 2020 Sep. 1, U.S. patent application Ser. No. 16/937,310, filed on 2020 Jul. 23, now U.S. Pat. No. 10,917,235, and U.S. Provisional Application No. 63/051,317, filed on 2020 Jul. 13 all of which applications are hereby incorporated by reference in their entireties.

### BACKGROUND OF THE INVENTION

Privacy-preserving multi-party computation (MPC) techniques enable multiple parties to collaboratively evaluate a function to produce a shared or revealed output while keeping the inputs private. Such computations are used, for example, in medicine and finance, when the input data comes from distinct private data sources that cannot disclose their data, but a public result based on the confidential data is needed.

A MPC is generally split both temporally and geographically across multiple participants. The participants, each of which represents a separate computing system, typically include k parties and one trusted dealer or honest-but-curious dealer. As used herein, the terms party and player are used interchangeably and refer to individual party computer systems participating in a multi-party computation.

After compilation of code to implement the computation, the dealer first executes an offline phase of the MPC. In the offline phase, the dealer produces masks (masking data, also referred to as triplets), and distributes shares of these masks to the parties such that each party knows only its share of the mask and none of them know the plaintext mask value represented by a sum of the shares. The determination of the masks typically depends on the data expected to be operated upon from statistical analysis perspective so that the masks are appropriately configured in relation to the data.

The k parties then collaboratively execute an online phase of the MPC, with synchronization steps where parties can exchange or broadcast messages according to a defined MPC protocol. The online phase can be run in a firewalled environment to which the dealer has no access.

A MPC can be the distributed equivalent of a plaintext pseudocode, which we can describe as a single static assignment (SSA) graph of MPC-friendly elementary operations. The nodes of the SSA graph are plaintext variables, and each party gets a local view (or secret share) of the variables. We denote this local view as an MPC container. The MPC-friendly elementary operations are referred to as builtins that take MPC containers and optionally some static parameters, as input and produce MPC containers as output.

FIG. 1 illustrates a schematic of MPC containers for k parties of a multi-party computation. Globally, a MPC container holds all the information about one variable in the SSA, namely, a plaintext value x that can be either public (known by all parties, but not the dealer) or a secret-shared [symbol] x [symbol] (each party knows its share only), one mask [symbol] y [symbol] (known by the dealer, and secret shared among all parties), and the optional masked value a=x+λ (known by all parties, but typically not the dealer). Notation note: the double square bracket notation [symbol] is used herein to denote a secret shared value.

Locally, each party has a trace of the MPC container, which can be a structure with fields as follows:

the public value x (if the container is publicly revealed)

one share xⱼ of the public value

one share λⱼ of the container's mask

the masked value a (if the container is masked and revealed).

Analyzing the union of the k containers, the following holds: the plaintext value of the container is by definition the sum of all shares Σxⱼ, if the container is public, all parties know the plaintext value, and each party has this value x populated. In this case, none of the other fields need be used in the MPC protocol. The mask of the container is λ=λⱼ. The value of the mask is known only by the dealer (during the offline phase). None of the parties knows or learns the actual mask during the online phase. The masked value a is equal to λ+x. The special mask-and-reveal operation instructs each party to broadcast its xⱼ+λⱼ, which allows them to jointly reconstruct and store the same field a=x+λ. All other technical or local variable that appears in the builtins are called ephemeral variables.

### SUMMARY OF THE INVENTION

An oblivious comparison method takes as input two secret shared numerical values x and y and outputs a secret shared bit that is the result of the comparison of x and y (e.g. 1 if x<y and 0 otherwise). The method uses secure multi-party computation, allowing multiple parties to collaboratively perform the comparison while keeping the inputs private and revealing only the result. The two secret shared values are subtracted to compute a secret shared result, the sign of which indicates the result of the comparison. The method decomposes the secret shared result into a masked Boolean representation and then performs a bit-wise addition of the mask and the masked result. Through the bit-wise addition the method can extract a secret shared representation of the most significant bit, which indicates the sign of the result, without revealing the result itself.

A method determines a secret shared indication of whether a secret shared numerical value a is less than a secret shared numerical value b. The method can be performed by a secure multi-party computing system configured for performing multi-party computations on secret shared values, the secure multi-party computing system including a dealer computing system and a plurality of party computing systems in secure networked communication. The method includes: each of the party computing systems storing a respective secret share of each of the values a and b; each of the party computing systems subtracting its secret share of b from its secret share of a to compute a respective secret share of a secret shared numerical value c; the dealer computing system and the plurality of party computing systems performing a first set of multiparty computations in order to decompose the secret shared numerical value c into a public Boolean array of bits C, representing the value c in a masked Boolean form, and a secret shared Boolean array Λ representing a mask for the array C; each of the party computing systems determining and storing a secret shared Boolean array of bits R, the array R comprising results of a bitwise (C OR Λ) operation performed on portions of the arrays C and Λ; the dealer computing system and the plurality of party computing systems performing a second set of multiparty computations sufficient to execute a bit-wise addition of the array Λ to the array C using the array R, wherein the bit-wise addition propagates carry bits from less significant bit positions to more significant bit positions up to a most significant secret shared bit; and each of the party computing systems storing a respective secret share of the most significant secret shared bit as the secret shared indication.

The method can be performed such that the second set of multiparty computations is performed using fewer rounds of communication than a total number of bits in the array C. The method can be performed such that the second set of multiparty computations is performed using order log(total number of bits in the array C) rounds of communication. The dealer can be a trusted dealer or an honest but curious dealer.

As will be appreciated by one skilled in the art, multiple aspects described in this summary can be variously combined in different operable embodiments. All such operable combinations, though they may not be explicitly set forth in the interest of efficiency, are specifically contemplated by this disclosure.

### BRIEF DESCRIPTION OF THE DRAWINGS

FIG. 1 illustrates a schematic of MPC containers for k parties of a multi-party computation.

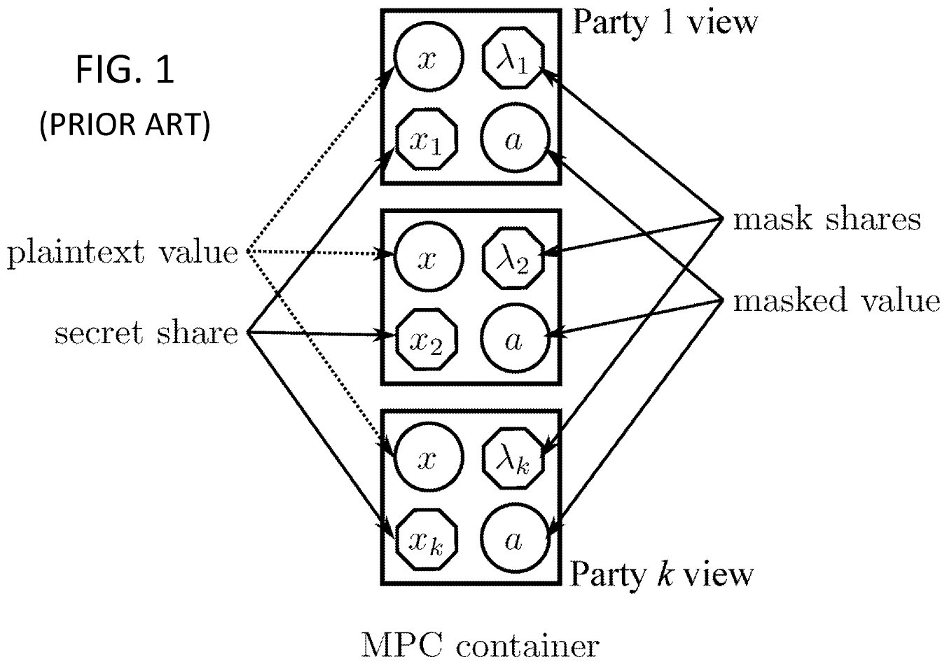

FIG. 2 illustrates pseudo-code for a naïve implementation of a private comparison method.

FIG. 3 illustrates a divide and conquer implementation of the private comparison method.

FIG. 4 illustrates a general computer architecture that can be appropriately configured to implement components disclosed in accordance with various embodiments.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted. By way of example, this disclosure may set out a set or list of a number of options or possibilities for an embodiment, and in such case, this disclosure specifically contemplates all clearly feasible combinations and/or permutations of items in the set or list.

### 1. INTRODUCTION

An oblivious comparison method takes as input two secret shared numerical values x and y (e.g., integers or real numbers) and outputs a secret shared bit that is the result of the comparison of x and y (1 if x<y and 0 otherwise). The method uses secure multi-party computation (MPC), that is, a cryptographic method allowing multiple parties to evaluate a function while keeping the inputs private and revealing only the output of the function and nothing else.

In one embodiment, the method can be implemented using the XOR Secret Computing Engine developed by Inpher, adopting the full-threshold model for MPC throughout and splitting the computation into online and online phases. The online phase (independent of the input data) can be performed by a trusted dealer or honest-but-curious dealer. Although the methods disclosed herein may in some cases be described with respect to the trusted dealer model, these methods can also be used with the honest but curious model.

### 2. NOTATION AND PRELIMINARIES

Definition 1 (secret sharing). If (G, +) is an abelian group, then an element x∈G is said to be secret shared among the k players P₁, . . . , Pₖ, if every player Pᵢ holds an xᵢ, such that x₁+x₂+ . . . +xₖ=x.

In most secret sharing protocols, the secret shares are assumed to satisfy additional statistical properties that ensure that no proper subset of the players learns any information about the secret x, even if they combine their secret shares. A data structure D represented as a string of bits D= [symbol] can be secret shared in two different ways as follows:
Arithmetic secret sharing scheme. We view D as an element of the abelian group G=( [symbol] , +) and secret-share it by uniformly drawing k−1 random elements x₂, . . . , xₖ from G and setting x₁=d−Σᵢ₌₂^{k} xᵢ(mod [symbol] )
Boolean secret sharing scheme. We view D as an array of bits of the abelian group G=( [symbol] , ⊕) and secret share each bit dⱼ by choosing uniformly at random k−1 elements x₂, . . . , xₖ from [symbol] /2 [symbol] and setting x₁=dⱼ ⊕ ⊕ᵢ₌₂^{k}xᵢ. As used here, the ⊕ operator denotes an exclusive OR (XOR) operation or equivalently bitwise addition modulo 2.

### 3. EVALUATING BINARY GATES

Let x be a boolean tensor. We use [symbol] x [symbol] _{⊕} to denote a k-tuple of tensors (x₁, . . . , xₖ) such that x₁ ⊕ . . . ⊕xₖ=x. If x₁, . . . , x_{k_1} are independent uniformly random tensors, we refer to [symbol] x [symbol] _{⊕} as secure boolean secret shares of x. We think of Boolean matrices as ordered sets of Boolean column vectors. Column vector operations are parallel and can be executed component-wise. In the following, we focus primarily on operations between single column matrices. Boolean sharing is the equivalent of additive sharing with coefficients over the field F₂ and as such, algorithms such as Beaver multiplication apply to this context as well.

3.1 XOR, Negation and Affine Combination

Both XOR and negation are operations that do not need precomputed triplets and thus, they can be performed without communication, each player operating directly on its secret shares. Let [symbol] x [symbol] _{⊕} and [symbol] y [symbol] _{⊕} be secret shares of two tensors x and y of the same dimension and let c be a constant public tensor of the same dimensions as x.
XOR: [symbol] x⊕ [symbol] _{⊕}= [symbol] x [symbol] _{⊕}+ [symbol] y [symbol] _{⊕} can be computed locally by each player, since the shares are in [symbol] /2 [symbol] .
Negation: [symbol] ¬x [symbol] _{⊕}=(¬x₁, . . . , xₖ). Only the first player negates its share, and all other players preserve their share. In particular, we emphasize that negation is NOT the opposite for the XOR law, in particular, [symbol] ¬x [symbol] _{⊕}≠¬ [symbol] x [symbol] _{⊕}. Instead, negation is similar to XOR-ing with a constant.
XOR with a constant: [symbol] x+c [symbol] =_{⊕}=(x₁+c, . . . , xₖ). Only the first player adds the constant, while all other players preserve their shares.
   In the three cases, the secret shares of the result can be computed locally by each player, and if the initial shares were secure (that is, x₁, . . . , x_{k_1} are independent and uniformly random), so are the resulting shares.

3.2 Public-Private AND Operations

In this section, we assume that [symbol] x [symbol] _{⊕} is a set of boolean secret shares of a tensor x and y is a public tensor of the same dimensions. Then, by distributivity of AND on XOR, we have

[symbol]

x AND y [symbol] _{⊕}= [symbol] x [symbol] _{⊕} AND y=(x₁AND y,x₂AND y,x₃AND y, . . . ,xₖAND y)

We may also extend this formula to negations of x or y:

[symbol]

¬x AND y [symbol] _{⊕}= [symbol] ¬x [symbol] _{⊕} AND y=(¬x₁AND y,x₂AND y, . . . ,xₖAND y)

[symbol]

x AND ¬y [symbol] _{⊕}= [symbol] ¬x [symbol] _{⊕} AND ¬y=(x₁AND ¬y, . . . ,xₖAND ¬y)

Most importantly, every player negates public values like y, whereas only one player negates secret shared values.

3.3 Private/Private AND Operations and Extensions

We now show how a single mask-and-reveal of [symbol] x [symbol] _{⊕} and [symbol] y [symbol] _{⊕} is sufficient to allow for local computation of all binary operations with inputs [symbol] x [symbol] _{⊕} and [symbol] y [symbol] _{⊕}. This is achieved through the use of beaver-triplets. Furthermore, we provide a general formula for the most common binary gates (AND, OR, NAND, NOR) to optimize complex logic gates and reduce communication/memory complexity.

Assume that we have secret shares [symbol] x [symbol] _{⊕}, [symbol] y [symbol] _{⊕}, [symbol] λ [symbol] _{⊕}, [symbol] μ [symbol] _{⊕} and [symbol] λ AND μ [symbol] _{⊕} of five single-column Boolean matrices x, y, λ, μ, λ AND μ of same length. The two columns x, y correspond to the secret plaintext. During the offline phase, the dealer draws λ, μ uniformly at random, computes λ AND μ, secret shares [symbol] λ [symbol] _{⊕}, [symbol] μ [symbol] _{⊕} and [symbol] λ AND μ [symbol] _{⊕} and distributes the shares to the players. Thus, at the beginning of the online phase, each player only knows its own share of the five columns. As in the standard Beaver multiplication, the players first apply a mask-and-reveal in order to get the two masked values a=x⊕λ and b=y⊕μ.

Writing x AND y=(a⊕λ) AND (b⊕μ), note that secret shares of [symbol] x AND y [symbol] _{⊕} can be linearized via following formula:

[symbol]

x AND y [symbol] _{⊕}= [symbol] λ AND μ [symbol] _{⊕}⊕( [symbol] y [symbol] _{⊕} AND b)⊕(a AND [symbol] μ [symbol] _{⊕})⊕(a AND b)

With the same mask-and-revealed setting, we can also negate x, y or both, taking advantage of the fact that ¬x=∥⊕¬a:

[symbol]

¬x AND y [symbol] _{⊕}= [symbol] λ AND μ [symbol] _{⊕}⊕( [symbol] y [symbol] _{⊕} AND b)⊕(¬a AND [symbol] μ [symbol] _{⊕})⊕(¬a AND b)

[symbol]

x AND ¬y [symbol] _{⊕}= [symbol] λ AND μ [symbol] _{⊕}⊕( [symbol] y [symbol] _{⊕} AND ¬b)⊕(a AND [symbol] μ [symbol] _{⊕})⊕(a AND ¬b)

[symbol]

¬x AND ¬y [symbol] _{⊕}= [symbol] λ AND μ [symbol] _{⊕}⊕( [symbol] y [symbol] _{⊕} AND ¬b)⊕(¬a AND [symbol] μ [symbol] _{⊕})_{⊕}(¬a AND ¬b)

In other words, we can always evaluate linear gates XOR; XNOR locally, and as long as one beaver triplet has been computed for x and y, and both have been masked-and-revealed, we can evaluate not only x AND y locally (the traditional bitwise Beaver product over [symbol] ₂), but also any other binary gate OR, NAND, NOR, : : : .

3.4 Selectors

All circuits can be expressed in terms of AND, XOR and negations. On top of that the MUX, or selector gate augments the logic on a data dependent expression. This gate takes one selector predicate s and two outcomes x, y, and based on the bit value of s, it returns either x or y. By definition, we have MUX(s, x, y), also denoted by s♭x: y, equal to:

MUX(s,x,y)=(s AND x)⊕(¬s AND y).

Note that we have

MUX(s,x,y)=(s AND x)⊕(¬s AND y)=y⊕(s AND (x⊕y)).

Since the previous section shows how to evaluate AND, XOR and negations, this yield a straightforward way of evaluating selector gates on secret shares.

### 4 LOW-LEVEL BUILTINS

On the XOR Secret Computing Engine, the Boolean operations are enabled by several low-level builtins which we explain in detail, namely, BooleanExpression, MaskAndDecomp and BooleanToModReal.

4.1 BooleanExpression

The BooleanExpression builtin outputs an n×m boolean matrix where each of the m output columns is a bit-wise expression of the input Boolean matrices. The BooleanExpression builtin consists of:
containerID—identifying the container for the output matrix;
a vector of m Statement(s) corresponding to them columns of the output matrix; and
pubCidSet—a list with the id(s) of the public containers (that is, containers known as public at compile time).

4.1.1 Statements

One column of the output is described by a Statement, which is either:
one Expression (introduced below); or
a select statement MUX(s(colS), e₁, e₂) for two Expression(s) e₁, e₂ based on a selector column s(colS) of a public container.

4.1.2 Expressions

The expression Expression, up to one optional global negation, is the XOR of a list of terms where each term can be:

And-term: (negX⊕x(colX)) AND (negY⊕y(colY))

Single-term: (negX⊕x(colX))

Here, x(colX) means the column number colX of the matrix x, which is referenced by its absolute containerID. negX⊕x(colX) leaves the possibility to negate this column whenever negX is true.

The value of the output container is obtained column by column by evaluating the corresponding statement. When all containers listed in the statements are public, the output container is public. Else, the output container is secret-shared. In the latter case, the formulas to compute the And-term and Single-term are given in Section 3.3.

4.1.3 The Statement Grammar

To be complete, this is the exact grammar of a valid Statement.

### Statement:=Selector|Expression

Selector:=(cId, colInd), Expression, Expression
Expression:=neg, vector<Term>

### Term:=AndTerm|SingleTerm

### AndTerm:=SingleTerm, SingleTerm

SingleTerm:=(neg, cld, colInd)

4.2 MaskAndDecomp

The builtin MaskAndDecomp takes as input a vector (of size n) of secret-shared real numbers and returns an n-by-m Boolean matrix of the bit-wise decomposition of the numbers (that is, it assumes the use of an m-bit numerical window to represent each real number). The bitwise decomposition is performed with the help of precomputed data from the trusted dealer. As such, the output of the builtin consists of a public n-by-m Boolean matrix C (the masked value in the real number representation) and a secret shared n-by-m boolean matrix A (the mask for the real number representation).

The reason why we need both C and Λ as opposed to just (boolean) secret shares of the resulting boolean matrix corresponding to x is the private comparison methods described below. For example, steps 3. and 5. in Method 1 use both C and Λ (in other words, we are using secret shares and not garbled circuits). The idea is that we cannot simply decompose a secret shared number by doing bit-wise decomposition locally as the latter would not yield Boolean secret shares of the bit-wise decomposition of the input vector. Note that we need to return the two Boolean matrices (the public C and the secret-shared Λ) precisely because the masking operation is on real numbers and not on Boolean matrices.

Letting λ and c be the real number representation of the mask and the masked value, respectively, and the upper-case letters Λ and C be the corresponding boolean matrices for the bitwise decomposition, and letting lsb and msb be the positions of the least and most-significant bits, respectively, C, and a Boolean matrix Λ, of same visibility as x, such that we have

(c+λ)2^{lsb}=x (mod 2^{msb}) where

$${\sum }_{j = 0}^{msb - lsb - 1} C ( : , j ) {2}^{j} = c ,$$

As used herein lsb and msb correspond respectively to the

$${\sum }_{j = 0}^{msb - lsb - 1} ⩓ ( : , j ) {2}^{j} = λ ,$$

parameters mMsb and pLsb as set out in U.S. Pat. No. 11,050,558, referenced above.

The builtin MaskAndDecomp consists of:
two output containerID(s)—one identifying the public container for the Boolean matrix C and one identifying the private (secret-shared) container for the boolean matrix A;
pubCidSet—a list with the id(s) of the public containers (that is, containers known as public at compile time);
one input containerID for the input vector of real numbers (of size n);
parameters msb and lsb used in the bitwise representation of the real numbers.
   Finally, if the input vector x is a secret-shared vector of real numbers then the offline phase of the builtin generates and secret shares a real mask λᵣₑₐₗ for the input. Furthermore, this mask gets negated and then converted to its Boolean representation λ_{⊕}. Finally the builtin generates secret shares of λ_{⊕} and adds them to the output container for Λ.

4.3 BooleanToModReal

This builtin should normally convert a Boolean matrix X of dimensions n×m to a vector z of size n of modular real numbers such that

$${z}_{i} = {2}^{lsb} {\sum }_{j = 1}^{m} {X}_{i , j} {2}^{j - 1} ,$$

∀ i=1, . . . n. For comparisons as well as computations of the max and min functions, we can restrict to the case m=1 (in this case, it is still important to convert a Boolean value to a modular real number as one would use the formula max(x,y)=x+p (y−x) where p is the predicate x≤y).

In this particular case, if the vector X is private, then the builtin masks and reveals Λ:=X⊕Λ where Λ is a uniformly random Boolean vector of size n. Furthermore, the players hold secret shares of the ModReal vector W:=2^{lsb}Λ computed by the dealer in the offline phase). For i=1, . . . , n, one then has

$${z}_{i} = \{ \begin{matrix}{W}_{i} & if X ⊕ ⩓ = 0 , \\ {2}^{lsb} - {W}_{i} & else\end{matrix} .$$

### 5 PRIVATE COMPARISON METHODS

Using the foregoing as building blocks, various methods for obliviously comparing two secret shared numerical values will now be described.

5.1 Defining Comparison for

[symbol]

We define comparison for the group ( [symbol] , +) as a means of comparing signed integers in the usual way: if x∈ [symbol] , we denote by x̅ the corresponding representative in {− [symbol] , . . . , [symbol] −1} (we call this lift x̅ the centered modular lift). By abuse of notation, given x∈ [symbol] , we also denote by x the standard lift (that is, the unique integer in {0, 1, . . . , [symbol] −1} that is x modulo [symbol] ).

For any two elements x,y∈ [symbol] , we say that x>y if and only if x̅>y̅. According to this definition, an element x∈{0, 1, . . . , [symbol] −1} is considered negative if the most significant bit is 1 and is considered positive otherwise.

5.2 The General Method

Several comparisons can be determined in parallel by taking two vectors or arrays of numbers to be compared, rather than taking single values to be compared. This implementation also supports single value comparisons in the case of a vector or array of dimension one. In one embodiment, we take as input two vectors a and b of [symbol] -bit signed integers (meaning that the plaintext values are [symbol] bits). Assume we represent the signed numbers in plaintext in {− [symbol] , . . . , [symbol] −1} as elements of [symbol] . This representation has a drawback that x>y does not imply that (x−y)>0. Since we would like to make use of the latter in the private comparison method (to get the Boolean value of the comparison out of the most significant bit of x−y), we look for a different representation.

It turns out that representing the [symbol] -bit signed numbers as the subset S:={0, . . . , [symbol] }∪{ [symbol] − [symbol] , . . . , [symbol] −1}⊂{0, . . . , [symbol] −1} has the desired property, namely that x>y⇒(x−y)>0. Let [symbol] = [symbol] +1. We assume that the numbers are arithmetically secret shared in the larger group G=( [symbol] , +). The output of the computation is an arithmetic secret shared vector β in ( [symbol] /2 [symbol] , +), such that the ith entry of β is 1 if the ith entry of b is greater than the ith entry of a and 0 otherwise.

Representing z as a string of [symbol] bits, this condition is equivalent to the condition of the most significant bit of z being zero. Therefore we can compare the two vectors a and b by calculating c=a−b and then extracting the vector of the most significant bits of c. The calculation of c is trivial. In fact, each player Pᵢ already holds a vector of arithmetic secret shares aᵢ of a and bᵢ of b. So each player calculates a vector of arithmetic secret shares cᵢ of c as cᵢ=aᵢ−bᵢ.

The extraction of the most significant bit of c is less obvious as there is a non linear dependency between the vector of the most significant bits of c and the matrix of bits of the secret shares of c. For that, we will use precomputed masking data from the dealer. Given a masking vector λ that is arithmetically secret shared among the players and given Boolean secret shares of its negated counterpart λ′=−λ; the players can extract the vector of most significant bits of c via the following method:

1. Mask and reveal the vector t=c+λ over [symbol]
2. Decompose each entry of t into its boolean representation, so that players know the plaintext vectors t₀, . . . , [symbol] where vector tᵢ corresponds to the vector of bits of t at position i.
3. Using the Boolean secret shares of λ′, the players can execute a bit-wise addition of λ′ to t and end up with boolean secret shares of c.
4. The players extract the Boolean shares of the vector of the most significant bits of c. They either set β to this vector or they lift it to arithmetic shares in another group.

5.3 The Naïve Implementation

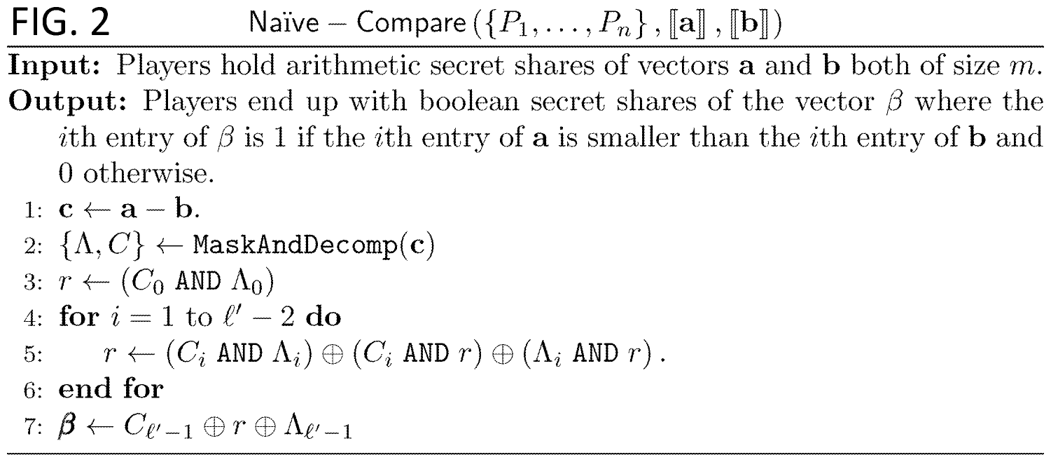

FIG. 2 illustrates pseudo-code for a naïve implementation of above private comparison method. The function MaskAndDecomp refers to the above special-purpose built-in that masks and reveals input c, decomposes c into its boolean representation C and distributes Boolean secret shares of λ′; which we will denote by Λ (steps 1 and 2 above). Note that the rows of a Boolean matrix correspond to the bit-string representation of a number, whereas the columns correspond to the vector of bits at the same position in the bit-string. Whenever we index a Boolean matrix, we reference to the corresponding column (the vector of bits at the same position). C can thus be represented as the concatenation of vectors C₀|C₁| . . . | [symbol] .

Referring to FIG. 2, at line 1, the secret shared number b is subtracted from the secret shared number a to obtain the secret shared number c. At line 2, the secret shared number c is masked and decomposed in a multiparty computation into the public Boolean matrix C and a secret shared Boolean mask matrix Λ. At line 3, the 0^{th} bits of each row of the C and Λ matrices are ANDed together to produce a secret shared Boolean vector r which used to store a carry bit as additional bits are evaluated.

At line 4, a for loop iterates the index i over the values 1 to [symbol] −2 to process the additional bits of the matrices. At line 5, which is executed in each iteration of the for loop, the vector r is assigned to the value of an expression that evaluates to the value of the carry bit for the sum of: the Boolean vales Cᵢ, Λᵢ, and the prior Boolean value of r. Line 6 closes the for loop.

At line 7, the carry from the next to last bit is represented by the secret shared vector r, which is effectively summed modulo 2 in a multiparty computation with the last bits of C and Λ, to produce the Boolean secret shares of the most significant bit of c.

It will be noted that the determination of (Λᵢ AND r) on line 5 involves a Beaver multiplication modulo 2 of the vectors Λᵢ and r, which requires one round of communication between the parties. Note that all the multiplications for each iteration of the index i can be performed using the same round of communications, but each iteration of the for loop requires a separate round of communication. Accordingly, for example, in comparing vectors of 128 bit arithmetic secret shared inputs, approximately 128 rounds of communication would be required.

5.4 The Divide and Conquer Implementation

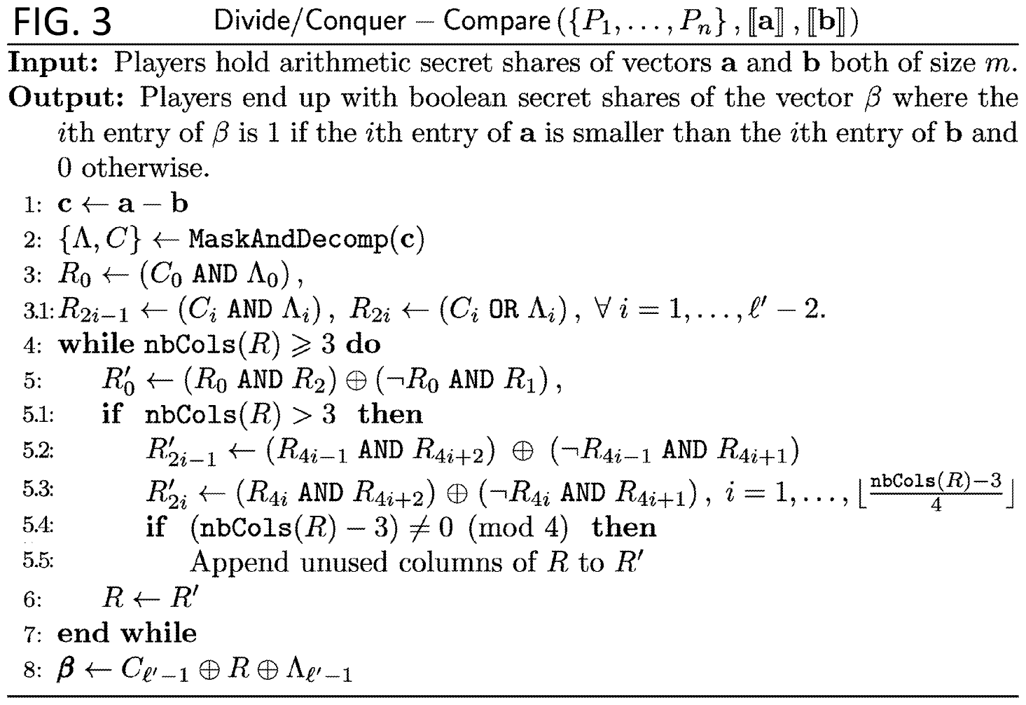

FIG. 3 illustrates a divide and conquer implementation of the private comparison method. In the illustrated divide and conquer implementation, the number of rounds of communication is reduced to order (log( [symbol] )) from order ( [symbol] ) in the naïve implementation. Lines 1 and 2 of FIG. 3 mirror those of FIG. 2.

At line 3, a first column R₀ of a temporary matrix R is assigned to C₀ AND Λ₀, which evaluates to the first bit of the bitwise addition of C and Λ resulting in a carry to the next bit. At line 3.1, we evaluate and store the values of two expressions for each column i through the remainder of the bits except the last. We evaluate (Cᵢ AND Λᵢ), which indicates that there will definitely be a carry from column/bit i. We also evaluate (Cᵢ OR Λᵢ), which indicates that there will be a carry if there is also a carry from the prior column i−1. In the implementation of FIG. 3, the values of these two expressions are stored in adjacent pairs of columns in the temporary matrix R for the indices 1 up to [symbol] −2. In additional or alternative embodiments, the values stored in the matrix R from the two expressions above could alternatively be stored in separate matrices or other separate or unified data structures depending on implementation.

At line 4, a while loop evaluates the number of columns in R using the function nbCols, and if the number of columns is at least three, then the body of the while loop is executed. The while loop is bracketed by an end while at line 7.

At line 5, a first column R′₀ of a second temporary matrix R′ is assigned to the output of a selector expression that depends on the value of R₀, which was assigned in line 3 to hold the carry result of the first bit of the bit-wise addition. Depending on whether the carry bit is 1 or 0, determines whether we look to the first or the second evaluated expression determined in line 3.1. If the carry bit is 1, then R₁, which is the OR of the next bit of the two addends, determines whether there is yet another carry to the next column. If the carry bit is 0, then R₁ determines whether there is yet another carry to the next column. The result of line 5 on a first iteration of the while loop is that the carry bit resulting from the bit-wise addition of both columns 0 and 1 of has now been collapsed down into column R′₀ of the second temporary matrix.

At line 5.1 an if statement evaluates whether the number of columns in R is greater than three. If so, then the next two lines 5.2 and 5.3 will iterate over the index i to evaluate successive groups of four columns of the matrix R (which correspond to two columns of the matrices C and A on a first iteration), to collapse those four columns down to two columns in the matrix R′. The groups of four columns that are evaluated are based the floor function evaluation at the end of line 5.3 that sets the range of the index i. The evaluation of the expressions on lines 5.2 and 5.3 operate similarly to the selector expression on line 5, but do so to create two new columns in the matrix R′ representing the equivalent of the AND and OR expressions evaluated on line 3.1.

At line 5.4, an if statement determines if any remaining columns of R were not processed in lines 5.2 and 5.3 are then at line 5.5 appends those remaining columns to R′ for further processing on a next iteration of the while loop. At line 6, the matrix R′ is assigned to replace the former matrix R and the while loop iterates again until there is only one column left in R.

At line 8, the carry from the next to last bit is represented by the single column secret shared matrix R, which is effectively summed modulo 2 in a multiparty computation with the last bits of C and Λ, to produce the Boolean secret shares of the most significant bit of c.

In the divide and conquer implementation of FIG. 2, each iteration of the while loop haves the number of columns remaining to process and so the while loop will iterate an order (log( [symbol] )) times. Although there are several multiparty computations within the while loop (six in the illustrated example), each of the computations is independent of the others, and so all of them can be performed using a single round of communication between parties in the multiparty computation system.

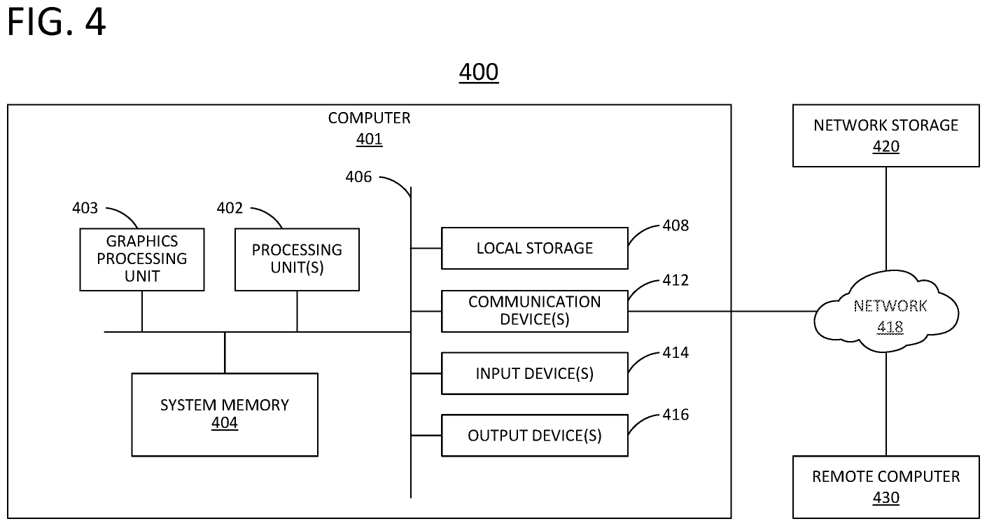

FIG. 4 illustrates an application of a private/oblivious comparison in performing trade matching, also referred to as axe matching, in a multiparty secret computing context. In FIG. 4, the ISIN refers to an International Securities Identification Number. Notionals refers to

### 6. COMPUTER IMPLEMENTATION

Components of the embodiments disclosed herein, which may be referred to as methods, processes, applications, programs, modules, engines, functions or the like, can be implemented by configuring one or more computers or computer systems using special purpose software embodied as instructions on a non-transitory computer readable medium. The one or more computers or computer systems can be or include one or more standalone, client and/or server computers, which can be optionally networked through wired and/or wireless networks as a networked computer system.

The special purpose software can include one or more instances thereof, each of which can include, for example, one or more of client software, server software, desktop application software, app software, database software, operating system software, and driver software. Client software can be configured to operate a system as a client that sends requests for and receives information from one or more servers and/or databases. Server software can be configured to operate a system as one or more servers that receive requests for and send information to one or more clients. Desktop application software and/or app software can operate a desktop application or app on desktop and/or portable computers. Database software can be configured to operate one or more databases on a system to store data and/or information and respond to requests by client software to retrieve, store, and/or update data. Operating system software and driver software can be configured to provide an operating system as a platform and/or drivers as interfaces to hardware or processes for use by other software of a computer or computer system. By way of example, any data created, used or operated upon by the embodiments disclosed herein can be stored in, accessed from, and/or modified in a database operating on a computer system.

FIG. 4 illustrates a general computer architecture 400 that can be appropriately configured to implement components disclosed in accordance with various embodiments. The computing architecture 400 can include various common computing elements, such as a computer 401, a network 418, and one or more remote computers 430. The embodiments disclosed herein, however, are not limited to implementation by the general computing architecture 400.

Referring to FIG. 4, the computer 401 can be any of a variety of general purpose computers such as, for example, a server, a desktop computer, a laptop computer, a tablet computer or a mobile computing device. The computer 401 can include a processing unit 402, a system memory 404 and a system bus 406.

The processing unit 402 can be or include one or more of any of various commercially available computer processors, which can each include one or more processing cores that can operate independently of each other. Additional co-processing units, such as a graphics processing unit 403, also can be present in the computer.

The system memory 404 can include volatile devices, such as dynamic random access memory (DRAM) or other random access memory devices. The system memory 404 can also or alternatively include non-volatile devices, such as a read-only memory or flash memory.

The computer 401 can include local non-volatile secondary storage 408 such as a disk drive, solid state disk, or removable memory card. The local storage 408 can include one or more removable and/or non-removable storage units. The local storage 408 can be used to store an operating system that initiates and manages various applications that execute on the computer. The local storage 408 can also be used to store special purpose software configured to implement the components of the embodiments disclosed herein and that can be executed as one or more applications under the operating system.

The computer 401 can also include communication device(s) 412 through which the computer communicates with other devices, such as one or more remote computers 430, over wired and/or wireless computer networks 418. Communications device(s) 412 can include, for example, a network interface for communicating data over a wired computer network. The communication device(s) 412 can include, for example, one or more radio transmitters for communications over Wi-Fi, Bluetooth, and/or mobile telephone networks.

The computer 401 can also access network storage 420 through the computer network 418. The network storage can include, for example, a network attached storage device located on a local network, or cloud-based storage hosted at one or more remote data centers. The operating system and/or special purpose software can alternatively be stored in the network storage 420.

The computer 401 can have various input device(s) 414 such as a keyboard, mouse, touchscreen, camera, microphone, accelerometer, thermometer, magnetometer, or any other sensor. Output device(s) 416 such as a display, speakers, printer, or eccentric rotating mass vibration motor can also be included.

The various storage 408, communication device(s) 412, output devices 416 and input devices 414 can be integrated within a housing of the computer, or can be connected through various input/output interface devices on the computer, in which case the reference numbers 408, 412, 414 and 416 can indicate either the interface for connection to a device or the device itself as the case may be.

Any of the foregoing aspects may be embodied in one or more instances as a computer system, as a process performed by such a computer system, as any individual component of such a computer system, or as an article of manufacture including computer storage in which computer program instructions are stored and which, when processed by one or more computers, configure the one or more computers to provide such a computer system or any individual component of such a computer system. A server, computer server, a host or a client device can each be embodied as a computer or a computer system. A computer system may be practiced in distributed computing environments where operations are performed by multiple computers that are linked through a communications network. In a distributed computing environment, computer programs can be located in both local and remote computer storage media.

Each component of a computer system such as described herein, and which operates on one or more computers, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

Components of the embodiments disclosed herein, which may be referred to as modules, engines, processes, functions or the like, can be implemented in hardware, such as by using special purpose hardware logic components, by configuring general purpose computing resources using special purpose software, or by a combination of special purpose hardware and configured general purpose computing resources. Illustrative types of hardware logic components that can be used include, for example, Field-programmable Gate Arrays (FPGAs), Application-specific Integrated Circuits (ASICs), Application-specific Standard Products (ASSPs), System-on-a-chip systems (SOCs), and Complex Programmable Logic Devices (CPLDs).

### 7. APPENDIX

This application includes a 10 page Appendix titled “A Quicksort Algorithm in the MPC Setting” that forms part of this disclosure.

### 8. CONCLUSION

Although the subject matter has been described in terms of certain embodiments, other embodiments that may or may not provide various features and aspects set forth herein shall be understood to be contemplated by this disclosure. The specific embodiments set forth herein are disclosed as examples only, and the scope of the patented subject matter is defined by the claims that follow.

In the claims, the terms “based upon” and “based on” shall include situations in which a factor is taken into account directly and/or indirectly, and possibly in conjunction with other factors, in producing a result or effect. In the claims, a portion shall include greater than none and up to the whole of a thing; encryption of a thing shall include encryption of a portion of the thing.

1. A method for determining a secret shared indication of whether a secret shared numerical value a is less than a secret shared numerical value b, the method being performed by a secure multi-party computing system configured for performing multi-party computations on secret shared values, the secure multi-party computing system comprising a dealer computing system and a plurality of party computing systems in secure networked communication, the method comprising:
each of the party computing systems storing a respective secret share of each of the values a and b;
each of the party computing systems subtracting its secret share of b from its secret share of a to compute a respective secret share of a secret shared numerical value c;
the dealer computing system and the plurality of party computing systems performing a first set of multiparty computations in order to decompose the secret shared numerical value c into a public Boolean array of bits C, representing the value c in a masked Boolean form, and a secret shared Boolean array Λ representing a mask for the array C;
each of the party computing systems determining and storing a secret shared Boolean array of bits R, the array R comprising results of a bitwise (C OR Λ) operation performed on portions of the arrays C and Λ;
the dealer computing system and the plurality of party computing systems performing a second set of multiparty computations sufficient to execute a bit-wise addition of the array Λ to the array C using the array R, wherein the bit-wise addition propagates carry bits from less significant bit positions to more significant bit positions up to a most significant secret shared bit; and
each of the party computing systems storing a respective secret share of the most significant secret shared bit as the secret shared indication.

2. The method of claim 1, wherein the second set of multiparty computations is performed using fewer rounds of communication than a total number of bits in the array C.

3. The method of claim 1, wherein the second set of multiparty computations is performed using order log(total number of bits in the array C) rounds of communication.

4. The method of claim 1, wherein the dealer is a trusted dealer.

5. The method of claim 1, wherein the dealer is an honest but curious dealer.
